(19) United States
(12) Patent Application Publication
(10) Pub. No.: US 2010/0205305 A1
(43) Pub. Date: Aug. 12, 2010

(54) METHOD AND APPARATUS FOR SERVICE LOCALIZATION

(75) Inventor: Gabor Bajko, Mountain View, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/690,594

(22) Filed: Jan. 20, 2010

Related U.S. Application Data
(60) Provisional application No. 61/145,939, filed on Jan. 20, 2009.

(51) Int. Cl. G06F 15/173

(52) U.S. Cl. 709/226

(57) ABSTRACT

A method comprises building a list of services available from stations associated with a network, wherein the list of services includes an indicator of a location of the station associated with each service.

### RELATED APPLICATION

This application claims priority to U.S. Provisional Patent Application Ser. No. 61/145,939, filed on Jan. 20, 2009, which is hereby incorporated by reference in its entirety.

### FIELD OF INVENTION

The present invention relates generally to the field of network communications and, more specifically, to service localization in such network communications.

### BACKGROUND OF THE INVENTION

This section is intended to provide a background or context to the invention that is recited in the claims. The description herein may include concepts that may be pursued, but are not necessarily ones that have been previously conceived or pursued. Therefore, unless otherwise indicated herein, what is described in this section is not prior art to the description and claims in this application and is not admitted to be prior art by inclusion in this section.

With the proliferation of wireless communication networks, various services may now be accessed through such networks. For example, in a home network (e.g., IEEE 802.11 network), a printer connected to one device or a network printer may be accessed wirelessly by a second device. In addition to homes, such networks may exist in other private areas, such as offices, as well as public areas, such as shopping malls and coffee shops. In this regard, through various communication devices, users may access services available through these networks.

### SUMMARY OF THE INVENTION

In one aspect of the invention, a method comprises building a list of services available from stations associated with a network, wherein the list of services includes an indicator of a location of the station associated with each service.

In one embodiment, the indicator of the location indicates whether the location is fixed or mobile. In one embodiment, if the location is fixed, the indicator further includes the location of the station. In one embodiment, if the location is mobile, the indicator further includes an area of service of the station. The indicator may include the location in geolocation coordinates. The indicator may include the location in civic parameters. In one embodiment, the station is an access point of the network or functions as a soft access point.

In another aspect of the invention, a method comprises requesting a list of services from an access point of a network; and receiving information related to one or more stations associated with the network offering services, the information including an indicator of a location of the station associated with each service.

In one embodiment, the method further comprises searching for networks offering the list of services prior to requesting the list of services. In one embodiment, the receiving information includes downloading the list of services. In one embodiment, the method further comprises displaying the location of the station associated with each service on a map application.

In another aspect of the invention, an apparatus comprises a memory unit and a processor communicatively connected to the memory unit. The processor is configured to build a list of services available from stations associated with a network, wherein the list of services includes an indicator of a location of the station associated with each service.

In another aspect of the invention, an apparatus comprises a memory unit and a processor communicatively connected to the memory unit. The processor is configured to request a service from an access point of a network and receive information related to a station associated with the network offering the service, the information including an indicator of a location of the station associated with each service.

In another aspect, a computer program product is embodied on a computer-readable medium and comprises computer code for building a list of services available from stations associated with a network, wherein the list of services includes an indicator of a location of the station associated with each service.

In another aspect, a computer program product is embodied on a computer-readable medium and comprises computer code for requesting a service from an access point of a network and computer code for receiving information related to a station associated with the network offering the service, the information including an indicator of a location of the station associated with each service.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Example embodiments of the invention are described by referring to the attached drawings, in which:

FIG. 1 is a schematic illustration of an arrangement in accordance with embodiments of the present invention;

FIG. 2 is an overview diagram of a system within which various embodiments of the present invention may be implemented;

FIG. 3 illustrates a perspective view of an exemplary electronic device which may be utilized in accordance with the various embodiments of the present invention; and

FIG. 4 is a schematic representation of the circuitry which may be included in the electronic device of FIG. 3.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

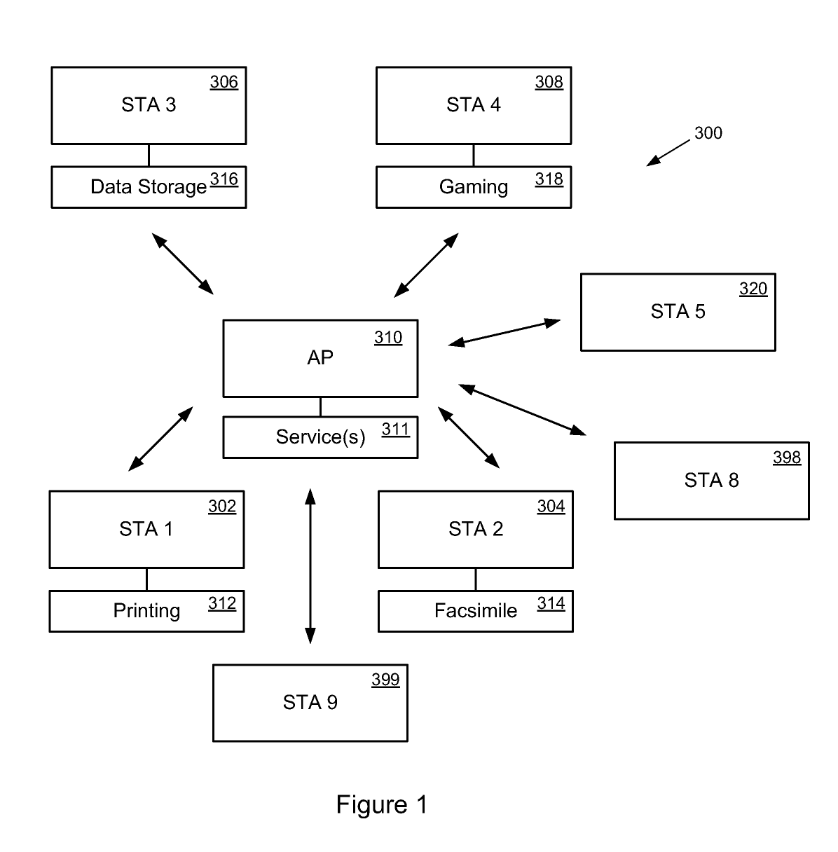

As noted above, in networks such as IEEE 802.11 networks, services may be available through various devices associated with the network. Referring now to FIG. 1, an arrangement of such a network is schematically illustrated. In FIG. 1, a network 300 includes an access point 310. The access point 310 may be a wireless router, for example. The access point 310 may allow communication between various stations 302, 304, 306, 308, 320, 398, 399 and other networks, such as the Internet.

One or more stations 302, 304, 306, 308 associated with the network 300 may make a service available through the network 300 (or the access point 310). For example, as illustrated in FIG. 1, station STA1 302 may offer a printing service 312, station STA2 304 may offer a facsimile service 314, station STA3 306 may offer a data storage service 316, and station STA4 308 may offer a gaming service 318. Other stations, such as STA5 320, STA8 398 and STA9 399 may offer no services.

For IEEE 802.11 networks, current standardization efforts are focusing on link layer service discovery. However, the current standardization efforts fail to provide any indication relating to the location of the stations associated with the network and offering the various services. The Universal Plug and Play (UPnP) and WiFi Alliance standards similarly fail to address this issue.

Referring again to FIG. 1, when a new user wishes to acquire a list of services available from the network, the new user may use a communication device, STA5 320, to query the access point 310. The access point 310 may provide STA5 320 with a list of the available services. However, it may not be apparent to the user of STA5 320 the location of the provider of each service. For example, if the user wishes to print pictures from STA5 320 using the printing service 312, the user would be unaware of where the pictures are to be picked up.

Embodiments of the present invention provide for the localization of such services. In accordance with embodiments of the present invention, the access point 310 builds a list of services available from stations associated with the network 300. The list may include services available from or hosted by the access point 310 itself. In this regard, when a station offering a service registers itself with the access point 310, it may provide the access point 310 with an indication of the nature of the service as well as information related to the location of the station providing the service. In one embodiment, the access point 310 may provide information related to an area in which the service is provided. Thus, the list of services compiled by the access point 310 may include indicators of the location of each station associated with each service.

It is noted that, in certain embodiments, the access point 310 may itself offer or host services. For example, as illustrated in FIG. 1, the access point 310 offers one or more services 311. In this regard, the list of services includes those services offered by the access point 310. In one embodiment, the access point 310 may be a network-capable device, such as a printer, which acts as an access point for offering its own service. In this regard, the network-capable device functions as a soft access point and may or may not offer services of other stations.

In various embodiments, the indicator of the location may indicate whether the location is fixed or mobile. For example, in the example illustrated in FIG. 1, certain services, such as printing 312, facsimile 314 and data storage 316, may be associated with a station that has a fixed location. By contrast, the gaming service 318 may be associated with a mobile station.

If the location of the service provider is fixed, the indicator of the location may further specify the location of the station. For example, the location of the station may be specified in geolocation coordinates, such as based on a GPS signal. In other embodiments, the location may be specified in civic parameters, such as an address, suite, floor or other such parameter. Location in terms of civic parameters may be useful, for example, when a GPS signal is not available (e.g., inside certain structures) or when the GPS coordinates may not be useful.

Once such a list has been compiled by the access point, it may be made available to stations that are associated with the access point and those that wish to become associated. Thus, when a station, such as STA5 320, desires to search for a service, it may search for available networks which make available a list of services. Upon discovering such networks, the station STA5 320 may request access to the list from one or more networks. Upon requesting a list from the network, the station STA5 320 may be provided with access to the compiled list. In accordance with certain embodiments, a station may request a service from the access point 310 of the network 300. The requesting station then receives the list which includes information related to stations associated with the network 300 that offer services. The information related to the stations may include indicators of the location of each station associated with each service. If the service sought by the station STA5 320 is on the list, the station STA5 320 may associate itself with the network 300.

Next, an exemplary implementation of an embodiment of the present invention is described in a IEEE 802.11 wireless local area network arrangement. In this regard, the list compiled by the access point may include an information element for each service and/or each station. The element may be as follows:

TABLE 1

| | | | | | | | B7 | | | | B8 |
|---|---|---|---|---|---|---|---|---|---|---|---|
| | | | B0-B3 | B4 | B5 | B6 | Emergency | Venue | 802.11 Venue | HESSID | Service |
| | Element ID | Length | NetworkType | Internet | ASRA | EASN | Network | Group | Type | (optional) | Capability List |
| Bits | | | 4 | 1 | 1 | 1 | 1 | | | | 1 |
| Octets | 1 | 3 or 9 | | | | | | 1 | 1 | 0 or 6 | |

The value of the Length field is the length of the Interworking capabilities field. The value of the length field is 3 if no HESSID is present, or 9 if a HESSID is present.

A non-access point station uses the Network Type field to indicate the desired Network Type in an active scan.

When the Service Capability List bit is set, it indicates support for building a Service Capability list. A station can build a list of services by collecting them from the associated non-access point stations. The list is then available upon request to the associated stations.

A Device Service Description information element, illustrated below as Table 2, contains information about the device and the services provided by the device joining the network. The Service Description element format is as follows:

TABLE 2

| | | | | | | | B0-B3 | | | |
|---|---|---|---|---|---|---|---|---|---|---|
| | | | | | | Hours of | Number of | | | Device |
| | | | Device | Device | Device | Operation | Services | Device | | Service #n |
| | Element ID | Length | UUID | Location | Type | (optional) | Supported | Service #1 | . . . | (optional) |
| Bits: | | | | | 1 | | 4 | | | |
| Octets: | 1 | 2 | 8 | variable | | | | variable | | variable |

The Length field in Table 2 is the length of the Device Service element. The value of the Length field is variable and depends on the number of Device Service fields and lengths present (e.g., Device Service #1 to Device Service #n).

Device UUID is the Universally Unique Identifier of the device.

Device Location field format is as follows:

TABLE 3

| | | | Location |
|---|---|---|---|
| | | Location | #2 |
| | Length | #1 | (optional) |
| Octets: | 1 | Variable | Variable |

Location in Table 3 has the following format:

TABLE 4

| | Length | type | Location |
|---|---|---|---|
| Octets: | 1 | 1 | Variable |

The type in Table 4 is either geolocation, case in which the location field of Table 4 is a Location Configuration Information (LCI), or civic location, case in which the location field is a binary encoded location as described in RFC4776.

Referring again to Table 2, Device Type is a one bit field. The bit set to one indicates a mobile device (no corresponding fixed location), while the bit set to zero indicates a fixed location.

The Hours of Operation field in Table 2 provides information relating the availability of certain aspects of the service. For example, in the case of the printing service 312, this field may provide the hours during which the physical location of the service is open for pick-up of printed material. The format for this field is shown in Table 5:

TABLE 5
Hours of Operation field

| | From | From | | To |
|---|---|---|---|---|
| | hours | Minutes | To Hours | Minutes |
| Octets: | 1 | 1 | 1 | 1 |

The Number of Services Supported field in Table 2 is a 4-bit field whose value is the number services provided by the device.

The Device Service field(s) of Table 2 has the following format:

TABLE 6

| | | Service | |
|---|---|---|---|
| | | Type | Supported |
| | Length | Code | Protocols |
| Octets: | 1 | 1 | Variable |

The Length field of Table 6 is the length of Device Service field of Table 2. Its value is variable and depends on the size of the other fields.

The Device Service field contains the Service Type code (shown in Table 6) which corresponds to a Service Name, as shown in Table 7:

TABLE 7

| Service Names | Service Type Codes |
|---|---|
| Unspecified | 0 |
| Printing | 1 |
| Digital Displaying | 2 |
| Projecting | 3 |
| Digital Camera | 4 |
| Scanning | 5 |
| Copying | 6 |
| Fax | 7 |
| Phone | 8 |
| Media Playing | 9 |
| Computer | 10 |
| Computer Pointing | 8 |
| Keyboard Input | 15 |
| Data Storing | 16 |
| Reserved | 17-127 |
| Vendor Specific | 128 |
| Reserved | 129-255 |

The Device Service Name is the functionality supported by the device.

The Device Service Type code is the value which is assigned to corresponding device functionality.

A Service Capability List may be included in native query protocol information ID definitions. The Service Capability List provides a list of services provided by the devices connected to the network. This list may be returned in response to a Native GAS Query Request. The format of the Device Service List element is provided in Table 8:

TABLE 8

| | | | | Supported | Device | Device | | Device |
|---|---|---|---|---|---|---|---|---|
| | | | Status | Service | Service #1 | Service #2 | | Service #n |
| | Info ID | Length | Code | Count | (optional) | (optional) | . . . | (optional) |
| Octets: | 1 | 2 | 2 | 1 | Variable | variable | | variable |

The Length field is 2-octet length of the Service Capability List element and is equal to 2 plus the lengths of Device Services present in the element.

The Status Code is a 2-octet field.

The Device Service field(s) format is shown in Table 6. It is variable length.

In one embodiment, a wifi interface on a device to search for available networks which have the bit “service capability list” set. Upon finding at least one such network, the device may download the device ID (UUID), service list and device location and other information described above. In this regard, the lists of each of one or more networks may be downloaded. The device may display the information from the list(s) using a map application to indicate the location of the various services. The user may select a desired service from the map application, thereby prompting the wifi interface to associate the device with the appropriate network. The device may then obtain access to the desired service.

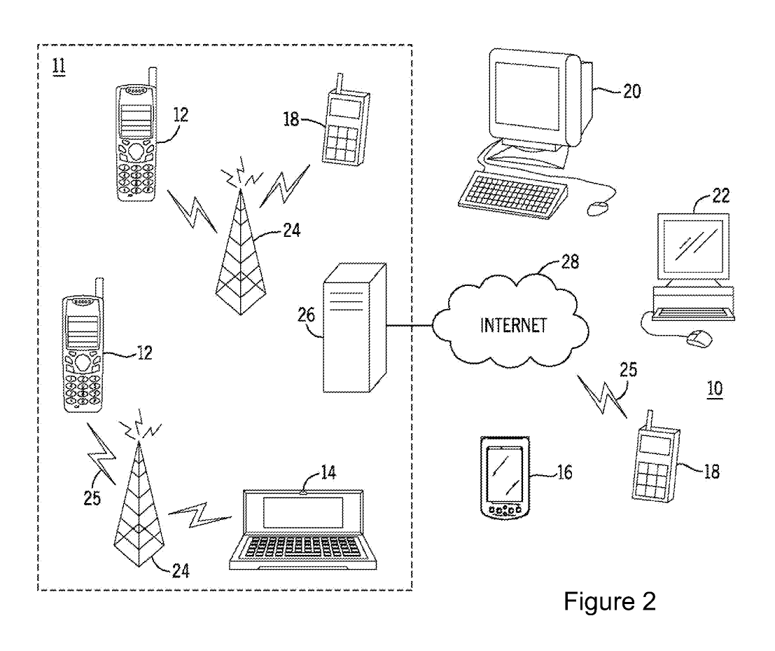

FIG. 2 shows a system 10 in which various embodiments of the present invention may be utilized, comprising multiple communication devices that may communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

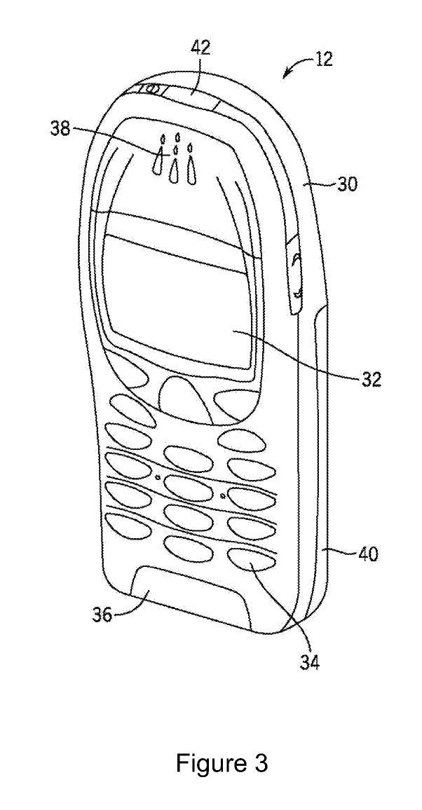

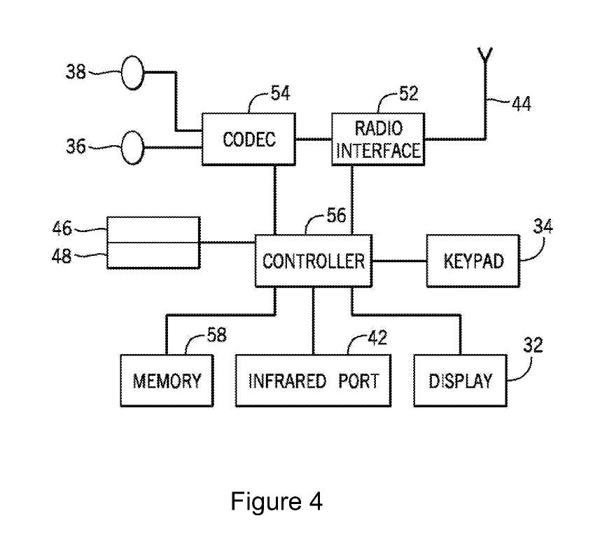

FIGS. 3 and 4 show one representative electronic device 28 which may be used as a network node in accordance to the various embodiments of the present invention. It should be understood, however, that the scope of the present invention is not intended to be limited to one particular type of device. The electronic device 28 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments may be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated

What is claimed is:

1. A method, comprising:
building a list of services available from stations associated with a network,
wherein the list of services includes an indicator of a location of the station associated with each service.

2. A method, comprising:
requesting a list of services from an access point of a network; and
receiving information related to one or more stations associated with the network offering services, the information including an indicator of a location of the station associated with each service.

3. An apparatus, comprising:
a memory unit; and
a processor communicatively connected to the memory unit, said processor being configured to:
build a list of services available from stations associated with a network,
wherein the list of services includes an indicator of a location of the station associated with each service.

4. The apparatus of claim 3, wherein the indicator of the location indicates whether the location is fixed or mobile.

5. The apparatus of claim 4, wherein, if the location is fixed, the indicator further includes the location of the station.

6. The apparatus of claim 4, wherein, if the location is mobile, the indicator further includes an area of service of the station.

7. The apparatus of claim 5, wherein the indicator includes the location in geolocation coordinates.

8. The apparatus of claim 5, wherein the indicator includes the location in civic parameters.

9. The apparatus of claim 3, wherein the station is an access point of the network or functions as a soft access point

10. An apparatus, comprising:
a memory unit; and
a processor communicatively connected to the memory unit, said processor being configured to:
request a list of services from an access point of a network; and
receive information related to one or more stations associated with the network offering services, the information including an indicator of a location of the station associated with each service.

11. The apparatus of claim 10, wherein the processor is further configured to:
search for networks offering the list of services prior to requesting the list of services.

12. The apparatus of claim 10, wherein the receiving information includes downloading the list of services.

13. The apparatus of claim 10, wherein the processor is further configured to:
display the location of the station associated with each service on a map application.

14. The apparatus of claim 10, wherein the indicator of the location indicates whether the location is fixed or mobile.

15. The apparatus of claim 14, wherein, if the location is fixed, the indicator further includes the location of the station.

16. The apparatus of claim 14, wherein, if the location is mobile, the indicator further includes an area of service of the station.

17. The apparatus of claim 15, wherein the indicator includes the location in geolocation coordinates.

18. The apparatus of claim 15, wherein the indicator includes the location in civic parameters.

19. The apparatus of claim 10, wherein the station is an access point of the network or functions as a soft access point.
